(19) United States
(12) Patent Application Publication
(10) Pub. No.: US 2017/0051609 A1
(43) Pub. Date: Feb. 23, 2017

(54) CONTROLLING A DOWNHOLE TOOL ON A DOWNHOLE CABLE

(71) Applicant: Halliburton Energy Services, Inc., Houston, TX (US)

(72) Inventors: Jerry Clinton Foster, Lewisville, TX (US); Dominick Joseph Bellotte, Flower Mound, TX (US); Richard Mineo, Richardson, TX (US); Jack Gammill Clemens, Fairview, TX (US)

(73) Assignee: Halliburton Energy Services, Inc., Houston, TX (US)

(21) Appl. No.: 15/303,717

(22) PCT Filed: May 13, 2014
(86) PCT No.: PCT/US2014/037910

§ 371 Date: Oct. 12, 2016

(51) Int. Cl. E21B 47/12; E21B 47/00; G02B 6/50; E21B 17/00

(52) U.S. Cl. CPC E21B 47/123; E21B 17/003; E21B 47/00; G02B 6/504; E21B 19/008

(57) ABSTRACT

Techniques for controlling a downhole tool include deploying a downhole tool on a slickline in a wellbore; receiving a command that includes at least one of data or logic at the downhole tool on the slickline from a controller; actuating the downhole tool, based on the command, with an actuator communicably coupled to the controller on the slickline; and transmitting feedback associated with the actuation of the downhole tool at the controller on the slickline.

### TECHNICAL BACKGROUND

This disclosure relates to communicating with a downhole tool on a downhole cable that includes a wire.

### BACKGROUND

Tools deployed on a downhole cable that includes a wire (e.g., wireline, slickline, and/or other downhole cable) have conventionally been activated by the use of mechanical manipulation, a timer, or temperature and pressure settings. These activation methods do not have the capabilities for precise control of the tools in the well from a terranean surface.

### DESCRIPTION OF DRAWINGS

FIG. 1 illustrates a schematic cross-sectional side view of an example well system with a downhole tool controllable on a downhole cable;

FIG. 2 illustrates an example downhole tool string that includes a downhole tool on a downhole cable;

FIG. 3 illustrates an example control loop for controlling a downhole tool on a downhole cable; and

FIG. 4 illustrates an example method performed with a downhole cable.

### DETAILED DESCRIPTION

The present disclosure describes example implementations of a control system for controlling one or more downhole tools coupled to a downhole cable, such as a mono-cable (e.g., slickline), wireline, e-line, or other cable that can transmit and receive information, such as logic and data, to and from the downhole tool. In some aspects, the information can include instructions or commands, such as a command, to the downhole tool, and the information can also include feedback (e.g., from sensors in or coupled to the tool) from the downhole tool in response to the instructions. In some aspects, the downhole cable can include one or more fiber optic wires, e.g., embedded in or coupled with the cable, such as a composite or non-metallic matrix.

Various implementations of a downhole tool control system in accordance with the present disclosure may include one, some, or all of the following features. For example, the system may provide for more precise control of downhole tools deployed on a wireline, slickline, e-line, or other wire in a wellbore. As another example, the control system may provide for closed loop control and feedback for a downhole tool deployed on a wire (e.g., slickline, wireline, e-line, or otherwise). As yet another example, the control system may provide for real-time control of a downhole tool deployed on a wire (e.g., slickline, wireline, e-line, or otherwise). The control system, for instance, may provide for communication, data transfer, and monitoring for downhole tools deployed on a wire (e.g., slickline, wireline, e-line, or otherwise). Other features may include, for instance, quicker downhole job completion due to, for example, high speed data transfer and communication on the wire; more intricate and higher revenue downhole jobs to be performed on simpler wire service (e.g., slickline) as compared to other services utilizing a braided line, tubing, or pipe; better design of downhole tools based on real-time data collected on jobs; and more accurate and quicker identification of root causes of downhole tool failures.

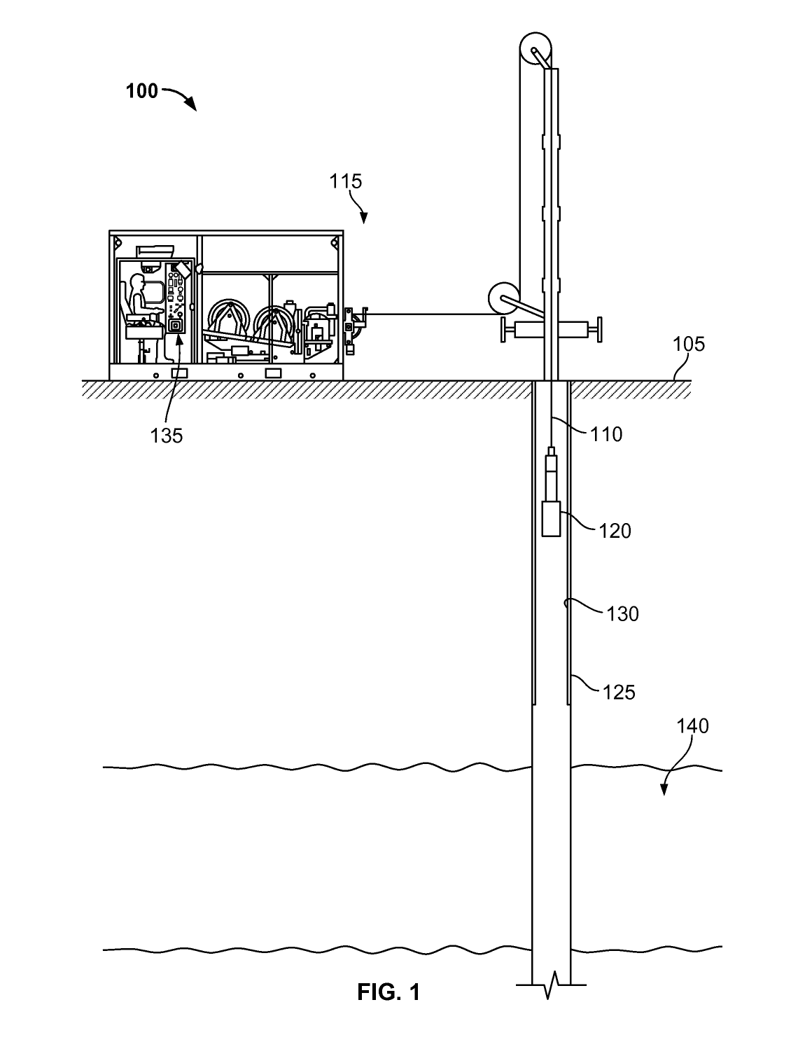

FIG. 1 is a schematic cross-sectional side view of a well system 100 with an example downhole cable 110. The well system 100 is provided for convenience of reference only, and it should be appreciated that the concepts herein are applicable to a number of different configurations of well systems. The well system 100 includes a wellbore 125 that extends from a terranean surface 105 (or from an ocean surface or other body of water) through one or more subterranean zones of interest 140. In FIG. 1, the wellbore 125 initially extends vertically and transitions horizontally. In other instances, the wellbore 125 can be of another position, for example, deviates to horizontal in the subterranean zone 140, entirely substantially vertical or slanted, it can deviate in another manner than horizontal, it can be a multi-lateral, and/or it can be of another position.

At least a portion of the illustrated wellbore 125 may be lined with a casing 130, constructed of one or more lengths of tubing, that extends from the terranean surface 105, downhole, toward the bottom of the wellbore 125. The casing 130 provides radial support to the wellbore 125 and seals against unwanted communication of fluids between the wellbore 125 and surrounding formations. Here, the casing 130 ceases at or near the subterranean zone 140 and the remainder of the wellbore 125 is an open hole, e.g., uncased. In other instances, the casing 130 can extend to the bottom of the wellbore 125 or can be provided in another position and in multiple circumferences or thicknesses (e.g., conductor casing or otherwise). In other instances, the wellbore 130 may be open hole (e.g., without casing).

As illustrated, a downhole tool string 120 is coupled to (e.g., supported by) the downhole cable 110, which can be, for example, a wireline, a slickline, an electric line. In the illustrated embodiment, the downhole cable 110 can support a downhole tool string (e.g., one or more downhole tools). In an example implementation, the downhole cable 110 includes a braided (e.g., multiple bound, or intertwined, wires such as wireline or electric line) line that includes one or more communication lines. The one or more communication lines is coupled with the braided line such as, for example, embedded in, intertwined with one or more wires, or wrapped around or within one or more wires, in a linear or non-linear (e.g., undulating, helical, zig-zag, or otherwise) configuration.

In another example implementation, the downhole cable 110 is a mono-cable. For instance, as a mono-cable, the downhole cable 110 is a single cable or single, solid wire that includes one or more communication lines. The mono-cable, in some aspects, is a slickline cable or other cable that is deployable (e.g., into and out of the wellbore 125) with slickline deployment tools or systems. The one or more communication lines is coupled with the solid wire such as, for example, embedded in or wrapped around or within the wire, in a linear or non-linear (e.g., undulating, helical, zig-zag, or otherwise) configuration.

In some aspects, a particular length (e.g., between two terminating ends) of the downhole cable 110 includes a length of the braided or solid wire and a length of the one or more communication lines. In the particular length of the downhole cable 110, the respective lengths of the braided or solid wire and the communication line may also terminate at or close to the terminating ends of the downhole cable 110. In some aspects, the length of the communication line may be greater than (e.g., slightly or substantially) the length of the braided or solid wire because of, for example, the non-linear configuration in which the communication line is coupled with the braided or solid wire.

As noted above, in some example implementations, the downhole cable 110 is a mono-cable (e.g., a slickline) that includes a solid wire and one or more communication lines. The mono-cable supports tool string 120 and can communicate instructions, data, and/or logic between the tool string 120 and a control system 135 on the terranean surface 105 though the communication line (e.g., optical fiber, metallic conductor such as copper or other conductor with appropriate dielectric properties, or non-metallic conductor). The communication line or lines of the mono-cable may be non-linearly coupled with the solid wire such that strain that exceeds a maximum allowable strain of the communication line, but not a maximum allowable strain of the solid wire, does not cause failure of the communication line or the mono-cable.

In some example implementations, a non-metallic/composite solid wire used in the downhole cable 110 may allow for a greater available working tension at the top of the tool string 120 (e.g., relative to a traditional slickline that is created using a billet of carbon or alloy steel that is drawn through a series of dies to obtain a required diameter, length, tensile strength, fatigue life and uniform cylindrical outside diameter), because the composite material may have a higher strength to weight ratio. The higher strength weight ratio may mean that the downhole cable 110 has a breaking strength per diameter that is less than that of conventional slicklines. But because the non-metallic/composite solid wire is lighter in weight than conventional slicklines, less tension may be required to overcome the weight of the solid wire in the wellbore 125. Thus, the non-metallic/composite solid wire used, and the downhole cable 110 itself, may still mechanically manipulate downhole components, such as, for example, shear pins, shift sleeves, and a variety of other mechanical applications.

In some example implementations, the downhole cable 110 that includes the non-metallic/composite solid wire coupled with the communication line or lines may include a coating (e.g., a non-abrasive smooth coating) applied to the cable 110. The coating may act as a barrier to prevent against abrasion, and may also give a uniform cylindrical surface for containing pressure. The coating may also give the non-metallic solid wire insulated properties, that may allow for fibers of the non-metallic solid wire to be used for data transmission or even power.

Further, due to the construction of the downhole cable 110, one or more fiber optic strands or conductors (e.g., communication lines) may be inserted into a metallic or non-metallic tube that is positioned at or near a middle or edge of the downhole cable 110 during a manufacturing process. Non-fiber conductors could also be placed in the tube. With the insertion of fiber optic(s) or conductor(s) or both, real time telemetry and power can now be accomplished using a downhole cable 110 that is deployable on slickline equipment, such as a cable deployment system 115 shown in FIG. 1.

The cable deployment system 115 may generally include one or more controllable reels or drums that spool a length of the downhole cable 110 to insert or extract the cable 110 into or from the wellbore 125. As illustrated, one or more pulleys and/or reeves may be mounted on a mast to ensure that the downhole cable 110 is lowered or raised into the wellbore with little or no interference.

In the illustrated implementation, the downhole tool string 120 may communicate with the control system 135 at the surface 105 using the communication capabilities of the downhole cable 110. For example, the downhole tool string 120 may send and receive electrical signals and/or optical signals (e.g., data and/or logic) through respective conductor wire and/or fiber optics of the communication line within the downhole cable 110. In addition, the downhole tool string 120 may be lowered or raised relative to the wellbore 125 by respectively extending or retrieving the downhole cable 110 on the cable deployment system 115.

In operation, generally, the downhole tool string 120 may be lowered into the wellbore 125 and, for instance, to a depth of the subterranean zone 140. Once at or near a desired depth for operation of one or more tools in the string 120, instructions, such as operational commands, may be transmitted by the control system 135 (or other controller part of or communicably coupled to the downhole tool string 120) to the downhole tool string 120. One or more downhole tools in the string 120 (e.g., setting tools, stroking tools, perforating tools) may be actuated based on the operational command(s).

In some aspects of the example operation, sensors that are part of the downhole tool string 120 or communicably coupled to the string 120 and/or downhole cable 110 may sense one or more downhole parameters (e.g., temperature, pressure, or otherwise) that may be adjusted or changed based on the actuation. Sensor feedback that is associated with the change in the one or more downhole parameters is then transmitted (e.g., in real-time or near real-time) on the downhole cable 110 to the control system 135. For instance, in some aspects, the feedback may be confirmation that a downhole tool has been actuated. In some aspects, the feedback may be collected data associated with the downhole parameter changes.

Further operational commands, instructions, or data from the control system 135 may be generated or adjusted based, at least in part, on the real-time feedback. These commands or instructions may include functions of the downhole tool string 120, including positioning, speeds, forces, power optimization, depth correlation, pressure sensing, temperature fluid sampling, flow measurements, and otherwise.

In some aspects, the above-described closed loop control system implemented on the downhole cable 110 may include a wide range of functions and read outs combined with high speed data transfer and communication, which may allow for more precise control (e.g., relative to traditional control on conventional slickline systems) with the tools from the surface 105. These precise controls may allow for smaller and less evasive interventions to be performed in a well, as one example benefit. The smaller and less evasive interventions minimize rig time, decrease well down time and bring smarter services to conventional slickline downhole tools.

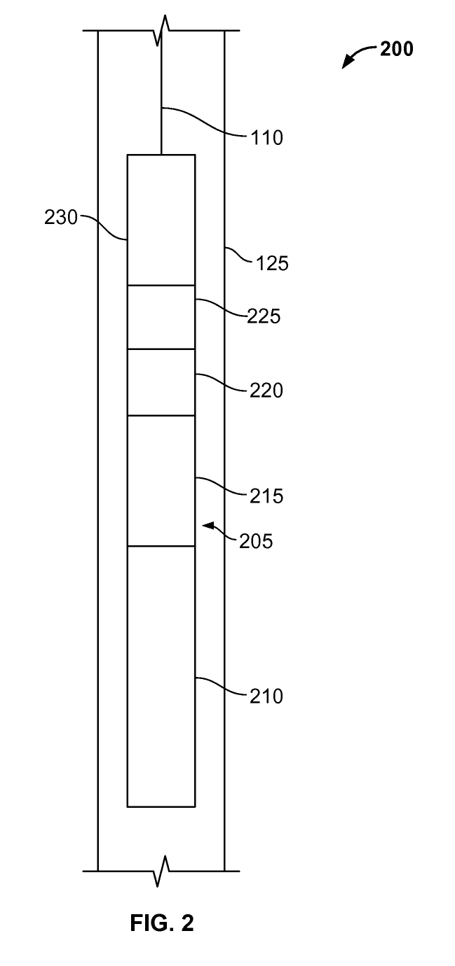

FIG. 2 illustrates an example control system for controlling a downhole tool on a downhole cable. In this example, which, in some aspects may be used in the well system 100, shown in FIG. 1, a downhole tool string 205 includes a downhole tool 210 and is deployable in the wellbore 125 on the downhole cable 110.

The example downhole tool 210 may be a variety of downhole tools. For example, it may be a perforating or other completion tool. It may be a setting tool or a shifting tool. In some examples, the downhole tool 210 may be a logging tool. In short, the present disclosure contemplates that the downhole tool 210 is not limited to any specific type of tool and may be any tool deployable, within or without a downhole tool string, on the example downhole cable 110.

An actuator 215 is communicably coupled with the downhole tool 210 in the tool string 205 in this example implementation. The actuator 215, in some aspects, may be an electro-mechanical actuator that received commands from a controller 225 (or other control system) and actuates the downhole tool 210 based on the commands.

The downhole tool 210 is coupled within the downhole tool string 205 to a sensor 220. The sensor 220 may be a single sensor, a set of sensors, or otherwise. As described above, the sensor 220 may also be independent of the downhole tool string 205 and positioned in the wellbore 125 to transmit data and/or feedback to a terranean surface or other location on the downhole cable 110 or otherwise. The sensor 220 may sense one or more downhole parameters (e.g., temperature, pressure, or otherwise) that may be adjusted or changed based on the actuation. Sensor feedback that is associated with the change in the one or more downhole parameters (or may simply indicate that the downhole tool 210 has been actuated) is then transmitted (e.g., in real-time or near real-time) on the downhole cable 110 to a surface or other control system.

The example downhole tool string 205 also includes a controller 225 that is communicably coupled with the downhole tool 210. In some aspects, the controller 225 (e.g., a downhole controller part of the downhole tool string) may be used in place of the control system 135 shown in FIG. 1 (e.g., a terranean surface based system). For example, the controller 225 may receive instructions or input from an operator and generate one or more commands to the downhole tool 210 based on the input. In some aspects, the controller 225 may receive data on the downhole cable 110 and determine one or more commands based on the data. In some aspects, the data may be explicit instruction to be sent to the downhole tool 210. In some aspects, the controller 225 may work within or with a terranean surface based control system, such as the control system 135.

The illustrated downhole tool string 205 also includes a downhole power supply 230. The power supply 230 provides power (e.g., electrical) to one or more components of the downhole tool string 205, such as, for instance, the downhole tool 210 and other components. In some aspects, the power supply 230 may be a battery powered power supply and may operate (e.g., the downhole tool 210) independently of any power being supplied (or not supplied) by the downhole cable 110. For instance, one example implementation of the power supply 230 may be a non-explosive, electro-mechanical setting tool that generates a precisely controlled linear force with real-time feedback delivered to actuate the downhole tool 210 (e.g., Halliburton's Downhole Power Unit (DPU®) Intelligent series tool).

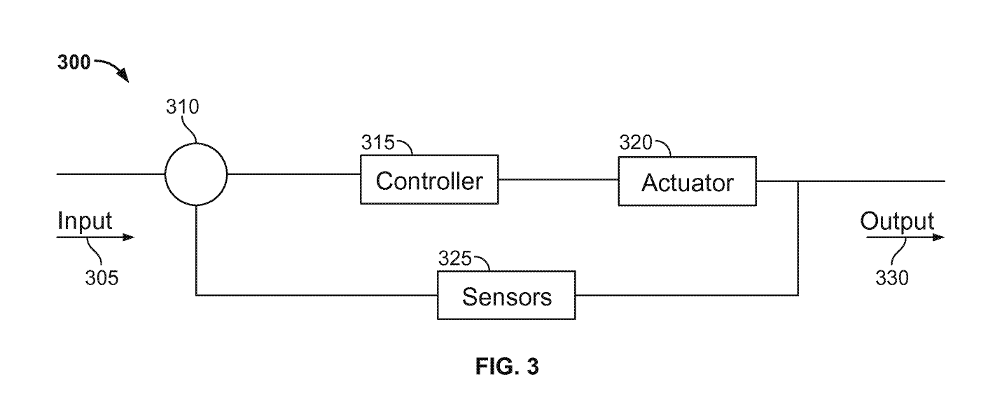

FIG. 3 illustrates an example control loop 300 for controlling a downhole tool on a downhole cable, such as the downhole tool 210 on the downhole cable 110 shown in FIG. 2. For instance, the loop 300 may include a control system 310 (e.g., at a terranean surface), a controller 315 (e.g., same as or similar to the controller 225), and an actuator 320 (e.g., same as or similar to the controller 225). Alternatively or additionally, the control loop 300 can describe an operation performed with the downhole tool string 120 or other downhole tool or downhole tool string according to the present disclosure.

In the illustrated control loop 300, data and/or instructions (e.g., logic) can be transmitted as an input 305 to a control system 310. In some aspects, the control system 310 may be a terranean based control system while the controller 315 is a downhole controller, e.g., coupled with a downhole tool in a downhole tool string. In some aspects, the control system 310 and the controller 315 may be the same or part of an overall controller of a well system. For instance, the control system 310 may be a portion of (e.g., a logic based comparator or otherwise) of the controller 315. The data and/or instructions as the input 310 may be a command to actuate a downhole tool, or may be data associated with one or more parameters of the downhole tool that, based on one or more algorithmic determinations by the controller 310, requires operation of the downhole tool.

As shown in this example, the input 305 or a command to the downhole tool (which may be part of or all of the input 305) is transmitted to the controller 315, e.g., on a downhole cable. Once a command is determined or recognized by the controller 315, it may be transmitted to the actuator 320.

The actuator 320 then prepares and sends an output 330 to the downhole tool. In some aspects, the output 330 may be an actuation signal sent by the actuator 320 to the downhole tool. In some aspects, the actuator 320 might simply actuate the downhole tool, or cause it to perform another operation, as part of the output 330.

Control loop 300 also includes one or more sensors 325 (e.g., downhole sensors) that measure one or more parameters (e.g., temperature, pressure, porosity, gamma, or any other downhole parameter). The sensors 325 may be coupled to the downhole tool or the downhole tool string. Thus, the sensors 325 may be able to measure, in real-time or near real-time, the parameters close (e.g., temporally) to actuation of the tool. The sensors 325, however, may also be independent of the tool or tool string. The sensors 325, for instance, may be a separate tool (e.g., logging tool) that is inserted in the wellbore after actuation of the downhole tool.

As illustrated, the sensors 325 provide feedback (e.g., real-time or near real-time) to the control system 310, e.g., through the downhole cable. In an alternative aspect, the sensors 325 may provide feedback to the controller 315, or to both the control system 310 and the controller 315. In some aspects, the control system 310 may be a portion of the controller 315 and include software and/or circuit based logic that compares the input 305 to the feedback from the sensors 325 to determine, for example, if any further action or correction of operation of the downhole tool is necessary or desired.

Thus, the control loop 300 may monitor output from the actuated downhole tool by the sensors 325, which is communicated back to an operator (e.g., operating the control system 310 and/or controller 315) in real-time on the downhole cable. With the feedback received from the tool, the operator may then modify or makes no changes to the functions of the downhole tool or downhole tool string in the wellbore. These modifications in the control loop 300 range from modifications in positioning, speeds, and/or forces, to power optimization, depth correlation, pressure sensing, temperature, fluid sampling, flow measurements, or otherwise.

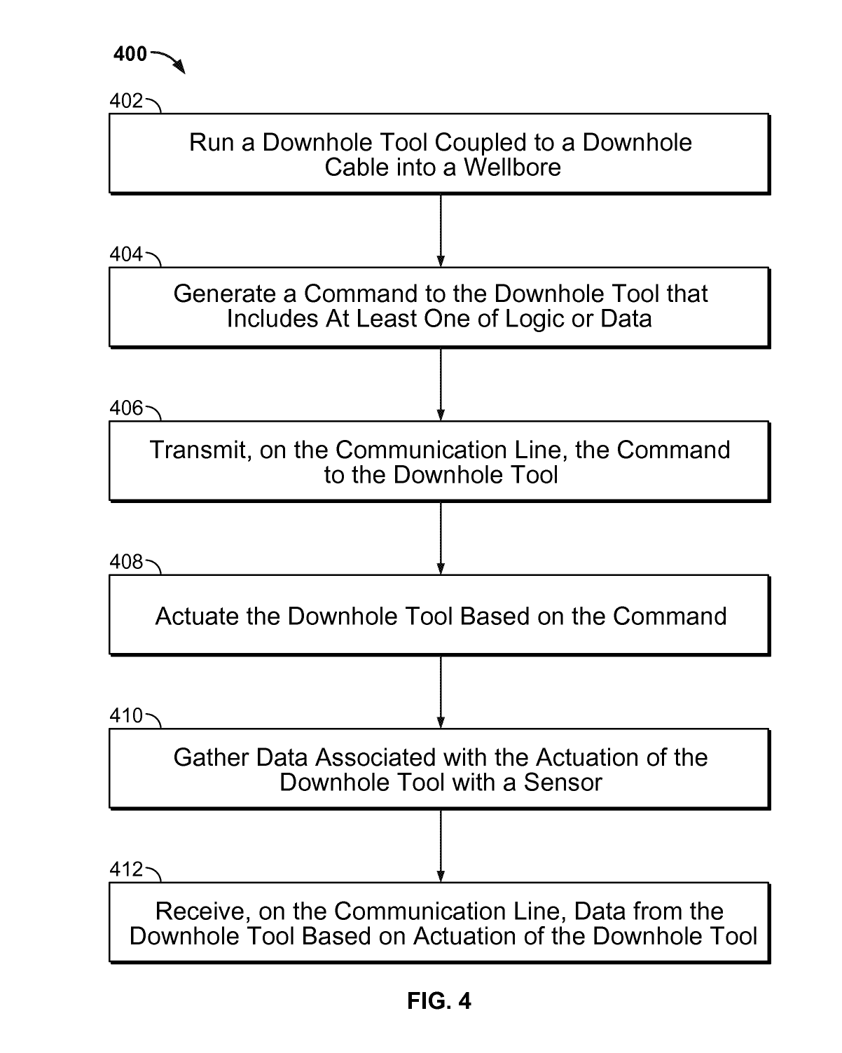

FIG. 4 illustrates an example method 400 performed with a downhole cable that inserts and extracts a downhole tool on a downhole tool string from a wellbore. Method 400 may be performed, for example, with the well system 100 and, more particularly, the downhole tool string 120 coupled to the downhole cable 110. Method 400 may also be performed, for example, with the the downhole tool string 205 coupled to the downhole cable 110.

In step 402, a downhole tool is run into a wellbore on a downhole cable. The downhole tool may be part of or coupled with a downhole tool string. In some aspects, the downhole cable may include a solid wire coupled with a communication line, such as described with reference to the downhole cable 110 shown in FIG. 1. For example, in some aspects, the downhole cable includes a slickline cable that has a solid, non-metallic or composite wire coupled with (e.g., formed around) one or more fiber optic stands as the communication line. In some aspects, the communication line may include both fiber optic strands and metallic conductors. In some aspects, the communication line may include only metallic conductors.

In step 404, a command to the downhole tool is generated. The command includes logic and/or data to be transmitted to the downhole tool. In some examples, the command to the downhole tool is a command to actuate the downhole tool.

In step 406, the command to the downhole tool is transmitted on the downhole cable to the downhole tool. In some aspects, the command may be transmitted from a terranean surface, such as from a controller or control system on the terranean surface. In some aspects, the command may be transmitted through the downhole cable from a location within the wellbore to the downhole tool. Further, in some aspects, the command may be transmitted to an actuator (e.g., an electro-mechanical actuator or otherwise) that is coupled with the downhole tool, rather than to the tool itself.

In step 408, the downhole tool is actuated based on receipt of the command. In some example, the downhole tool is actuated (e.g., shifted, set, or otherwise depending on the type of tool) by the actuator that receives the command. In some examples, “actuation” of the downhole tool may include performing an operation different than an initial actuation (e.g., shifting open or close, moving to a different wellbore location, or otherwise).

In step 410, data that is associated with the actuation or operation of the downhole tool is gathered with one or more sensors. The data may be associated with the downhole tool (e.g., to show an actuation event occurred) and/or may be associated with one or more downhole parameters that may change based on actuation or operation of the downhole tool. In some examples, for instance, the sensors may sense a change in downhole parameters (e.g., temperature, pressure, flowrate, or otherwise) that can be attributed to the actuation or operation of the downhole tool.

In step 412, the data is sent to, and received by, a controller or control system on the downhole cable. In some aspects, this data feedback may initiate further operations of the downhole tool. For example, based on the data, another command may be generated (e.g., for a different operation or another operation similar to that of step 408). The feedback, for instance, may allow an operator to better understand downhole conditions after the actuation of the downhole tool in step 408. Thus, another command can be generated and transmitted on the downhole cable to further operate the downhole tool (e.g., as many times as needed or desired).

The features described (e.g., the controller 220, the control system 310, the controller 315, and/or the control system 135) can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the claims.

In a general implementation, a downhole tool system includes a mono-cable to support a downhole tool string. The mono-cable includes a wire and one or more communication lines coupled with the wire. The one or more communication lines are sized to communicate instructions that include at least one of logic or data to the downhole tool string. The system further includes a downhole tool coupled to the wire in the downhole tool string; and a controller that includes a processor and a memory device coupled to the processor that includes a set of instruction that, when executed by the processor, cause the processor to perform operations. The operations include generating a command to the downhole tool; transmitting, on the one or more communication lines, the command to the downhole tool; and receiving, on the one or more communication lines, data from the downhole tool based on execution of the command by the downhole tool.

A first aspect combinable with the general implementation further includes a power source electrically coupled with the downhole tool string.

In a second aspect combinable with any of the previous aspects, the power source includes a portion of the downhole tool.

In a third aspect combinable with any of the previous aspects, the power source includes a battery.

In a fourth aspect combinable with any of the previous aspects, the downhole tool includes a sensor, and the data from the downhole tool is generated by the sensor.

In a fifth aspect combinable with any of the previous aspects, the one or more communication lines includes an optical fiber strand or a conductor.

In a sixth aspect combinable with any of the previous aspects, the one or more communication lines includes a plurality of optical fiber strands.

In a seventh aspect combinable with any of the previous aspects, the wire includes a composite or non-metallic material.

In an eighth aspect combinable with any of the previous aspects, the mono-cable includes a slickline, and the wire includes a single solid wire.

In a ninth aspect combinable with any of the previous aspects, the controller includes a portion of the downhole tool string.

In a tenth aspect combinable with any of the previous aspects, the command includes a first command.

In an eleventh aspect combinable with any of the previous aspects, the operations further include, based on the received data from the downhole tool, generating a second command to the downhole tool, the second command different than the first command; and transmitting, on the one or more communication lines, the second command to the downhole tool.

In another general implementation, a method for controlling a downhole tool includes running a downhole tool coupled to a mono-cable into a wellbore, the mono-cable including a wire and one or more communication lines coupled with the wire; generating a command to the downhole tool, the command including at least one of logic or data; transmitting, on the one or more communication lines, the command to the downhole tool; and receiving, on the one or more communication lines, data from the downhole tool based on execution of the command by the downhole tool.

In a first aspect combinable with the general implementation, the command includes a first command and the method further includes based on the received data from the downhole tool, generating a second command to the downhole tool, the second command different than the first command; and transmitting, on the one or more communication lines, the second command to the downhole tool.

A second aspect combinable with any one of the previous aspects further includes performing an operation with the downhole tool in the wellbore based on the command.

A third aspect combinable with any one of the previous aspects further includes supplying power to the downhole tool, with a power source that includes a portion of the downhole tool, to perform the operation.

In a fourth aspect combinable with any one of the previous aspects, receiving, on the one or more communication lines, data from the downhole tool based on execution of the command by the downhole tool includes receiving, on the one or more communication lines, data from a sensor that includes a portion of the downhole tool string.

In a fifth aspect combinable with any one of the previous aspects, the one or more communication lines includes at least one optical fiber strand or a conductor.

In a sixth aspect combinable with any one of the previous aspects, the mono-cable includes a slickline, and the wire includes a single solid wire.

In another general implementation, a method for controlling a downhole tool includes deploying a downhole tool on a slickline in a wellbore; receiving a command that includes at least one of data or logic at the downhole tool on the slickline from a controller; actuating the downhole tool, based on the command, with an actuator communicably coupled to the controller on the slickline; and transmitting feedback associated with the actuation of the downhole tool at the controller on the slickline.

In a first aspect combinable with the general implementation, the slickline includes one or more optical fiber stands.

In a second aspect combinable with any one of the previous aspects, the command and the feedback are received and transmitted, respectively, on the one or more optical fiber strands.

In a third aspect combinable with any one of the previous aspects, the slickline further includes a non-metallic or composite material.

In a fourth aspect combinable with any one of the previous aspects, the one or more optical fiber strands are at least partially embedded in the non-metallic or composite material.

A fifth aspect combinable with any one of the previous aspects further includes performing an operation with the downhole tool based on the received feedback.

In a sixth aspect combinable with any one of the previous aspects further includes generating the feedback associated with the actuation of the downhole tool with one or more sensors communicably coupled with the downhole tool.

In a seventh aspect combinable with any one of the previous aspects, the controller is positioned at or near a terranean surface.

A number of examples have been described. Nevertheless, it will be understood that various modifications may be made. Accordingly, other examples are within the scope of the following claims.

What is claimed is:

1. A downhole tool system, comprising:
a mono-cable to support a downhole tool string, the mono-cable comprising a wire and one or more communication lines coupled with the wire, the one or more communication lines sized to communicate instructions that comprise at least one of logic or data to the downhole tool string;
a downhole tool coupled to the wire in the downhole tool string; and
a controller comprising a processor and a memory device coupled to the processor, the memory device comprising a set of instruction that, when executed by the processor, cause the processor to perform operations comprising:
generating a command to the downhole tool;
transmitting, on the one or more communication lines, the command to the downhole tool; and
receiving, on the one or more communication lines, data from the downhole tool based on execution of the command by the downhole tool.

2. The downhole tool system of claim 1, further comprising a power source electrically coupled with the downhole tool string.

3. The downhole tool system of claim 2, wherein the power source comprises a portion of the downhole tool.

4. The downhole tool system of claim 3, wherein the power source comprises a battery.

5. The downhole tool system of claim 1, wherein the downhole tool comprises a sensor, and the data from the downhole tool is generated by the sensor.

6. The downhole tool system of claim 1, wherein the one or more communication lines comprises an optical fiber strand or a conductor.

7. The downhole tool system of claim 6, wherein the one or more communication lines comprises a plurality of optical fiber strands.

8. The downhole tool system of claim 1, wherein the wire comprises a composite or non-metallic material.

9. The downhole tool system of claim 1, wherein the mono-cable comprises a slickline, and the wire comprises a single solid wire.

10. The downhole tool system of claim 1, wherein the controller comprises a portion of the downhole tool string.

11. The downhole tool system of claim 1, wherein the command comprises a first command, and the operations further comprise:
based on the received data from the downhole tool, generating a second command to the downhole tool, the second command different than the first command; and
transmitting, on the one or more communication lines, the second command to the downhole tool.

12. A method for controlling a downhole tool, comprising:
running a downhole tool coupled to a mono-cable into a wellbore, the mono-cable comprising a wire and one or more communication lines coupled with the wire;
generating a command to the downhole tool, the command comprising at least one of logic or data;
transmitting, on the one or more communication lines, the command to the downhole tool; and
receiving, on the one or more communication lines, data from the downhole tool based on execution of the command by the downhole tool.

13. The method of claim 12, wherein the command comprises a first command, the method further comprising:
based on the received data from the downhole tool, generating a second command to the downhole tool, the second command different than the first command; and
transmitting, on the one or more communication lines, the second command to the downhole tool.

14. The method of claim 12, further comprising performing an operation with the downhole tool in the wellbore based on the command.

15. The method of claim 14, further comprising supplying power to the downhole tool, with a power source that comprises a portion of the downhole tool, to perform the operation.

16. The method of claim 12, wherein receiving, on the one or more communication lines, data from the downhole tool based on execution of the command by the downhole tool comprises:
receiving, on the one or more communication lines, data from a sensor that comprises a portion of the downhole tool string.

17. The method of claim 12, wherein the one or more communication lines comprises at least one optical fiber strand or a conductor.

18. The method of claim 12, wherein the mono-cable comprises a slickline, and the wire comprises a single solid wire.

19. A method for controlling a downhole tool, comprising:
deploying a downhole tool on a slickline in a wellbore;
receiving a command that comprises at least one of data or logic at the downhole tool on the slickline from a controller;
actuating the downhole tool, based on the command, with an actuator communicably coupled to the controller on the slickline; and
transmitting feedback associated with the actuation of the downhole tool at the controller on the slickline.

20. The method of claim 19, wherein the slickline comprises one or more optical fiber stands, and the command and the feedback are received and transmitted, respectively, on the one or more optical fiber strands.

21. The method of claim 20, wherein the slickline further comprises a non-metallic or composite material, and the one or more optical fiber strands are at least partially embedded in the non-metallic or composite material.

22. The method of claim 19, further comprising performing an operation with the downhole tool based on the received feedback.

23. The method of claim 19, further comprising generating the feedback associated with the actuation of the downhole tool with one or more sensors communicably coupled with the downhole tool.

24. The method of claim 19, wherein the controller is positioned at or near a terranean surface.
